(19) United States
(12) Patent Application Publication
(10) Pub. No.: US 2025/0061784 A1
(43) Pub. Date: Feb. 20, 2025

(54) PRINTING PATTERNS ON PHYSICAL REEL STRIPS FOR LIGHT DIFFUSION

(71) Applicant: IGT, Las Vegas, NV (US)

(72) Inventors: Rachel GUTHRIE, Carson City, NV (US); Cullen O'Day, Reno, NV (US)

(73) Assignee: IGT, Las Vegas, NV (US)

(21) Appl. No.: 18/449,235

(22) Filed: Aug. 14, 2023

(51) Int. Cl. G07F 17/34; B41M 5/00; G07F 17/32

(52) U.S. Cl. CPC G07F 17/34; B41M 5/0047; G07F 17/3211

(57) ABSTRACT

A physical reel strip can be configured to be positioned in a slot machine. The reel strip can include a transparent surface and a light-diffusion layer coupled to the transparent surface.

### BACKGROUND

Embodiments described herein relate to electronic gaming machines (“EGMs”). EGMs can include one or more games (e.g., wagering games) stored therein that can be played by a player. The EGM can provide a prize to the player based on a wager and an outcome of a wagering game. An example of a wagering game includes a slot game in which, in response to receiving a wager from the player, one or more rows of symbols are revealed. In some examples, the symbols can be affixed to one or more reel strips. Each reel strip can separately spin to produce the one or more rows of symbols. A prize can be provided to the player based on the one or more rows of symbols including one or more winning combinations of symbols.

### SUMMARY

According to some embodiments, a physical reel strip configured to be positioned in a slot machine is provided. The reel strip includes a transparent surface. The reel strip further includes a light-diffusion layer coupled to the transparent surface.

According to other embodiments, a method of providing a physical reel strip configured to be positioned in a slot machine is provided. The method includes providing a transparent surface. The method further includes printing a light-diffusion layer on the transparent surface.

According to other embodiments, a slot machine is provided. The slot machine includes a physical reel and a light source. The physical reel includes a transparent surface and a light-diffusion layer attached to the transparent surface. The light source is positioned behind a portion of the physical reel and is configured to direct a light toward a portion of the physical reel. The light-diffusion layer is configured to reduce an amount of the light that passes through the light-diffusion layer by a threshold amount.

According to other embodiments, a method, an EGM, a system, or non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIG. 3 is a schematic diagram illustrating an example of a gaming device that includes a light source and a physical reel according to some embodiments;

FIGS. 4A-D are schematic diagrams illustrating an example of a physical reel strip and layers of the physical reel strip according to some embodiments;

FIG. 5 is a schematic diagram illustrating an example of a gaming device that includes a light source and an alternative physical reel according to some embodiments;

FIG. 6 is a schematic diagram illustrating an example of a gaming device that includes a light source, an alternative physical reel, and a symbol screen according to some embodiments;

FIGS. 7A-H are schematic diagrams illustrating examples of an ink pattern for a light-diffusion layer of a physical reel according to some embodiments; and

FIG. 8 is a flow chart illustrating an example of operations to manufacture a physical reel strip with a light-diffusion layer according to some embodiments.

### DETAILED DESCRIPTION

A gaming device such as an electronic gaming machines (“EGMs”) can include reel games also referred to as slot machines. The gaming device can include a physical reel (including multiple physical reel strips) and a light source that acts as a backlight by shining a light through the physical reel towards a user. A physical reel strip can each include a transparent surface with a plurality of symbols attached (e.g., printed) thereon. The light can pass through the physical reel strip and illuminate a portion of the symbols that are on a portion of the physical reel strip.

Currently manufacturing a physical reel strip includes printing two ink layers on a clear polyester substrate: first a background layer (e.g., including a white ink fill layer for the reel strip background) and then a symbol layer (e.g., including a layer of color inks for the symbol art). Behind some of the symbols of the symbol layer, areas of the background layer can be “knocked out” from the reel strip background. This knock out process removes or reduces the opacity of the ink on the background layer.

In some examples, the light source can cause hot spots (e.g., areas that appear brighter and/or heat up). The hot spots can cause problems including eye strain for users and damage to the physical reel strip. A secondary textured material can be adhered to the reel strip (either behind or on top of the printed symbol layer), which can help to create a much clearer image once the symbol is backlit. This secondary textured material can act as a diffuser to help evenly distribute the backlighting hotspots on symbols that the game design intends to emphasize, making the symbol art more legible that it would be without the diffuser material and casing player eye strain.

Various embodiments herein describe printing an diffusion layer onto the physical reel strip using ink instead of applying a secondary textured material to the reel strip. In some embodiments, a process is provided for printing a layer of ink in the form of a pattern or patterns (e.g., behind a reel strip's symbol art and onto the physical reel strip) to cause backlight diffusion. This diffusion layer can diffuse the reel strip's backlight hot-spots to help even out the illumination and reduce eye-strain, while still allowing more light to pass through the reel strip substrate in order to emphasize a game's special or higher value symbol. This innovation differs from the current practice of physically adhering a textured secondary diffusion material to the reel strip.

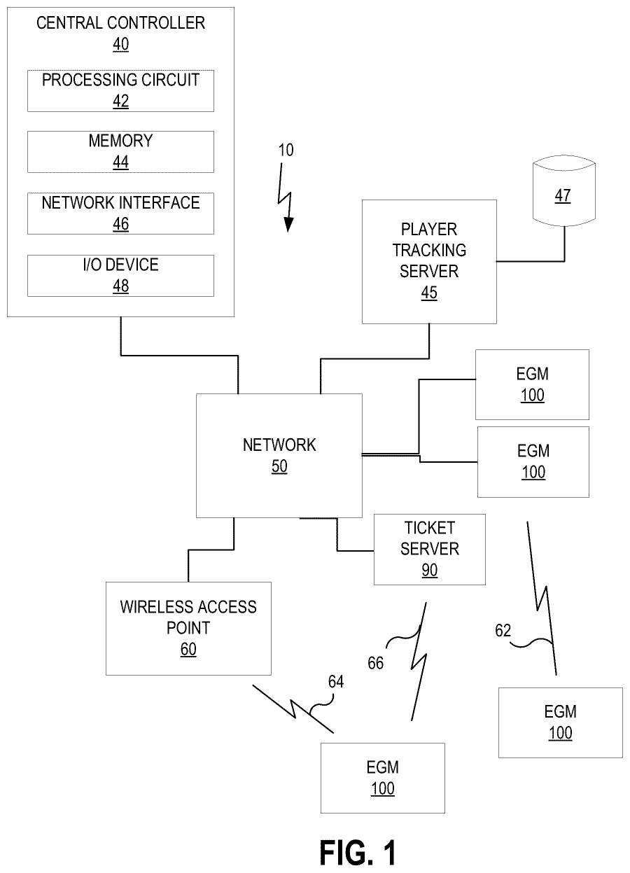

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

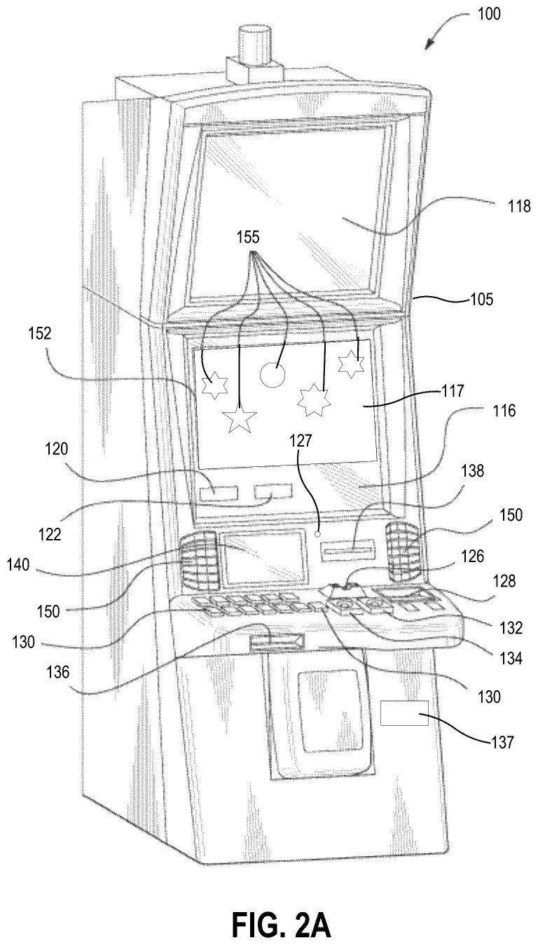

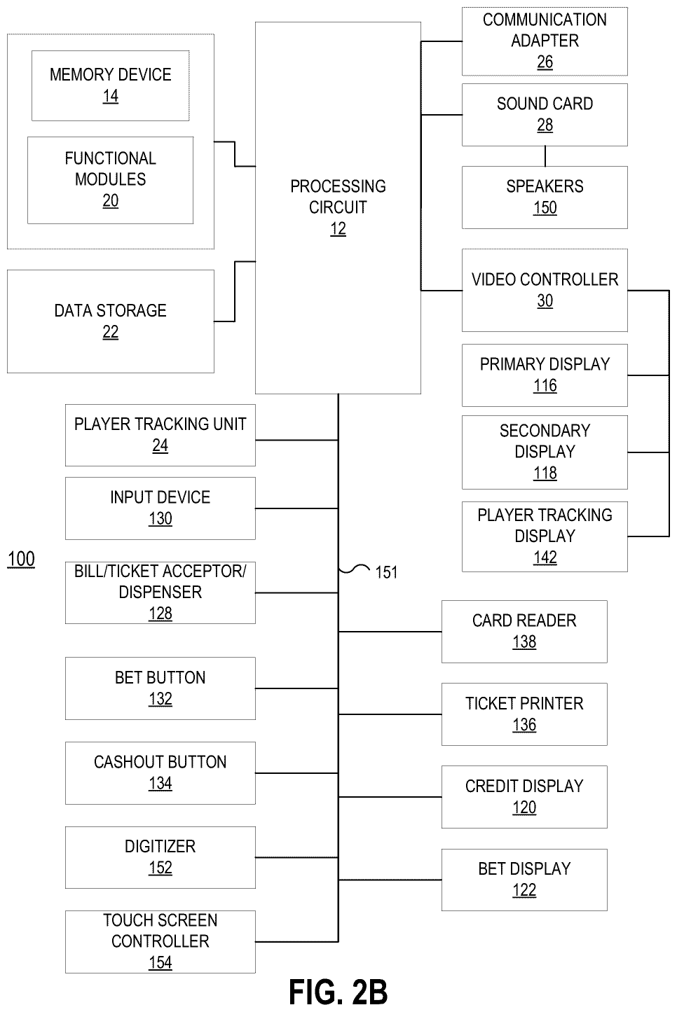

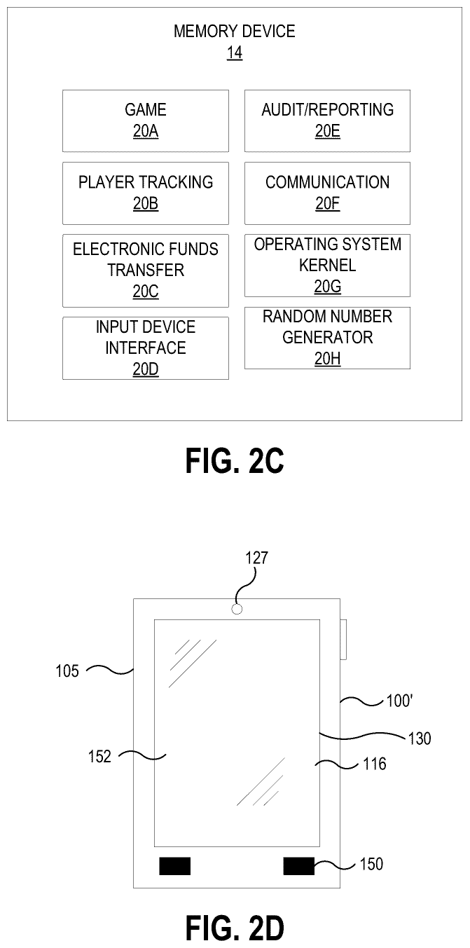

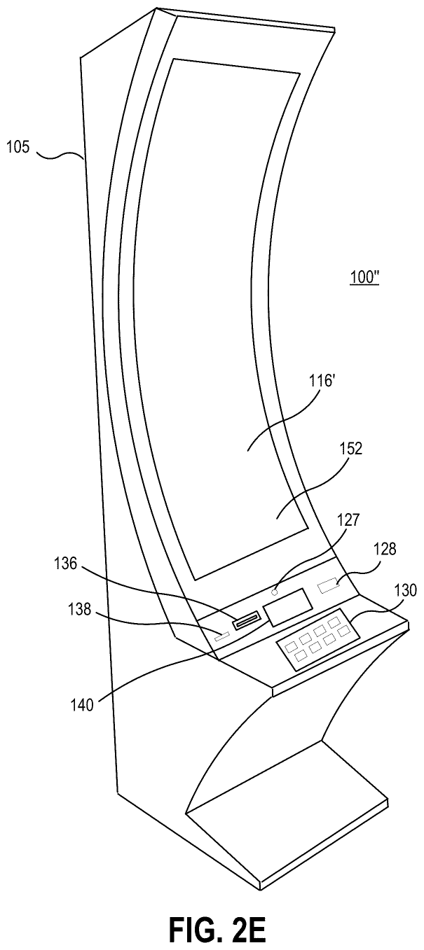

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

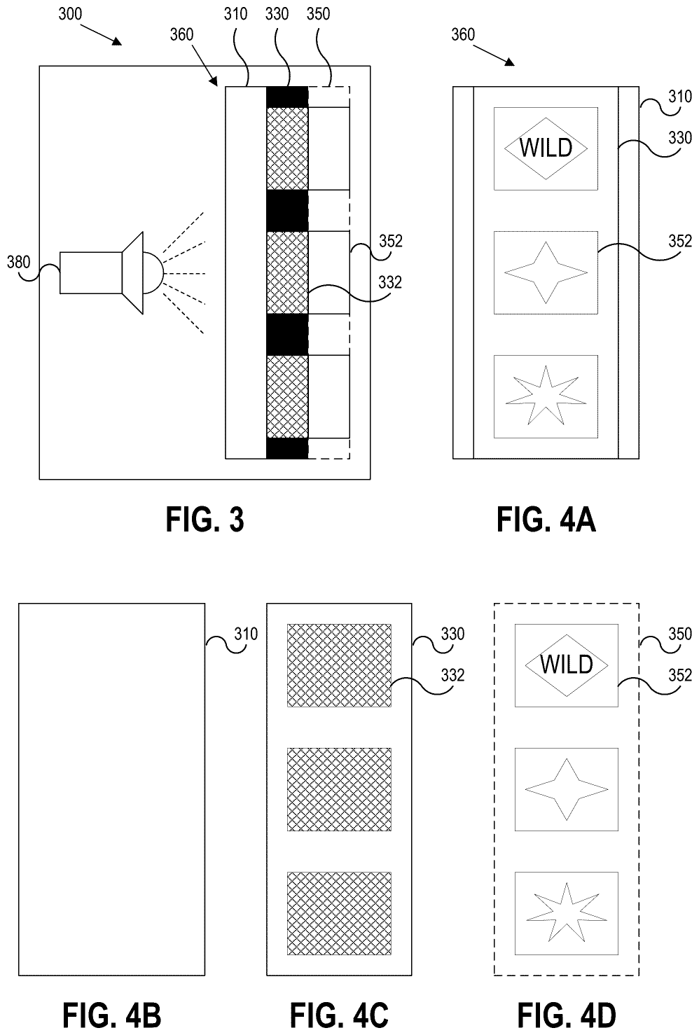

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein describe printing patterns on physical reel strips for light diffusion using ink. instead of gluing a secondary textured material to the reel strip. The ink patterns can be printed behind the color symbol art layer with the intent of evenly diffusing the LED hot spot backlighting without the use of a secondary diffuser material.

FIG. 3 illustrates an example of an EGM 300 including a light source 380 configured to transmit light through a physical reel strip 360. The physical reel strip 360 includes a transparent surface 310, a diffuser layer 330 (also referred to herein as a light-diffusion layer), and a symbol layer 350. The diffuser layer 330 can include an ink layer printed on the transparent surface 310. The diffuser layer 330 can include portions of solid ink and portions that include an ink pattern 332. The symbol layer 350 can include an ink layer printed on the diffuser layer 330. The symbol layer 340 can include symbols 352 printed on the ink patterns 332 of the diffuser layer 330. FIGS. 4A-D illustrate examples of the physical reel strip 360, the transparent surface 310, the diffuser layer 330, and the symbol layer 350 respectively.

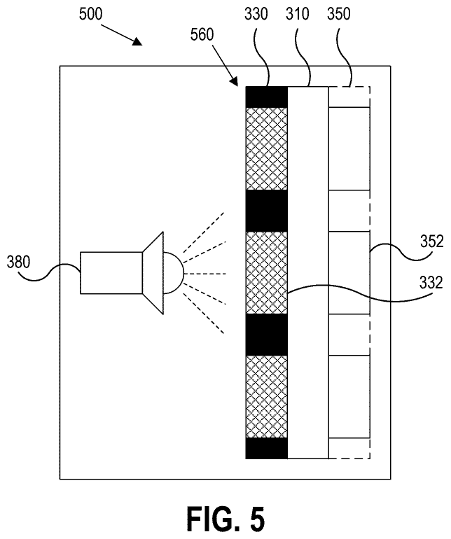

FIG. 5 illustrates an example of an EGM 500 including a light source 380 configured to transmit light through a physical reel strip 560. The physical reel strip 560 includes the diffuser layer 330 and the symbol layer 350 printed on opposite sides of the transparent surface 310. The symbols 352 can be positioned on the transparent surface 310 based on a position of a corresponding ink pattern 332 of the diffuser layer (and/or relative to a position of the light source 380). Although FIG. 5 illustrates the diffuser layer 330 being printed on a back side of the transparent surface 310 (e.g., a side of the transparent surface closer to the light source 380), other implementations are possible. For example, the diffuser layer 330 may be printed on a front side of the transparent surface 310 (e.g., a side of the transparent surface farther from the light source 380).

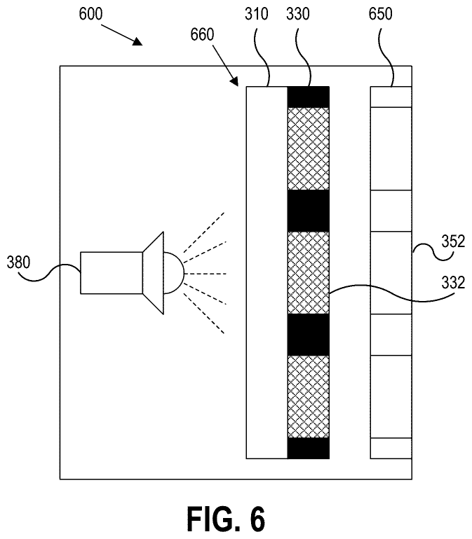

Although FIGS. 3-5 describe a physical reel strip that includes a symbol layer, some EGMs include a semi-transparent screen (configured to virtually display one or more symbols) that is separate from the physical screen. FIG. 6 illustrates an example of an EGM 600 including a light source 380 configured to transmit light through a physical reel strip 660 and a screen 650. The physical reel strip 660 includes the diffuser layer 330 printed on one side (here the front side but it could be the back side) of the transparent surface 310. The symbols 352 can be displayed on the screen 650 at a position corresponding to a position of a corresponding ink pattern 332 of the diffuser layer (and/or relative to a position of the light source 380).

In some embodiments, a light-diffusion layer can be configured to reduce an amount of light that passes through the physical reel strip by a threshold amount. In additional or alternative embodiments, an opacity, a color, or a pattern of the ink used in a light-diffusion layer can be determined based on at least one of: an intensity of a light source; a distance between the light source and the physical reel strip; and a game symbol associated with the physical reel strip. The phrase “at least one of” is used herein to indicate that each of the elements may be independent or in combination with any of the other elements. For example, the opacity, the color, or the pattern can be based on (individually or in combination) any of the intensity of a light source, the distance between the light source and the physical reel strip, and the game symbol associated with the physical reel strip.

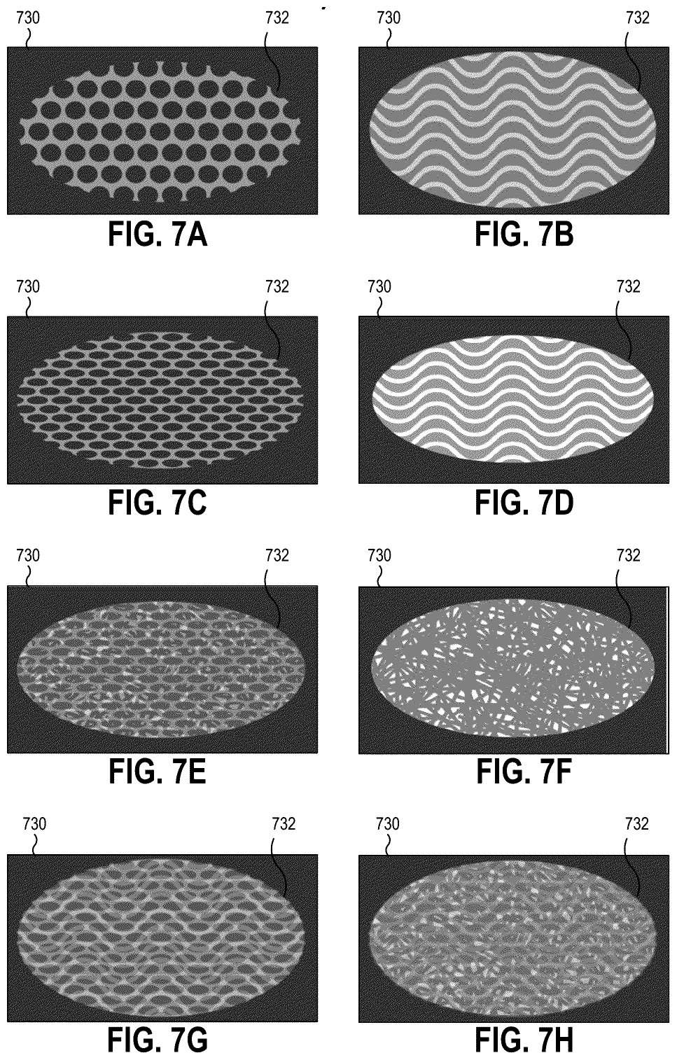

FIGS. 7A-H illustrate examples of a diffuser layer 730 including a solid ink portion and an ink pattern 732. In some examples, the diffuser layer 730 is printed as part of the physical reel (e.g., on the transparent surface behind the symbol layer), and configured to diffuse light passing through the physical reel strip without the use of a secondary diffuser material. This can be achieved through the combination of the printed pattern itself, and the opacity of the printed pattern. FIGS. 7A-D illustrate examples of single repeating patterns. FIGS. 7E-H illustrate examples of multiple repeating and/or pseudo-random patterns. In some examples, the term pattern is used herein to refer to any non-solid distribution of ink.

In some embodiments, the ink used for the solid ink portion and/or the ink pattern may be selected to adjust the amount and/or a characteristic of the light passing through the physical reel strip. In some examples, the ink used for the diffuser layer 730 may include a medium gray, blue, or purple ink printed with 50% opacity. In additional or alternative examples, the diffuser layer may include overlaying different color inks (e.g., using complementary colors such as horizontal blue stripes, overlaid by vertical orange stripes) to achieve a desired diffusion effect. In additional or alternative examples, the diffuser layer may include varying levels of opacity to achieve a desired diffusion effect.

Various embodiments described herein provide technical advantages. In some embodiments, a quicker and cheaper process for manufacturing reel strips is provided. In some examples, the process for manufacturing reel strips allows for greater design flexibility for symbol illumination. In additional or alternative examples, the process for manufacturing reel strips includes a reduced cost due to a reduction (and/or elimination) of the use of a textured material for light diffusion.

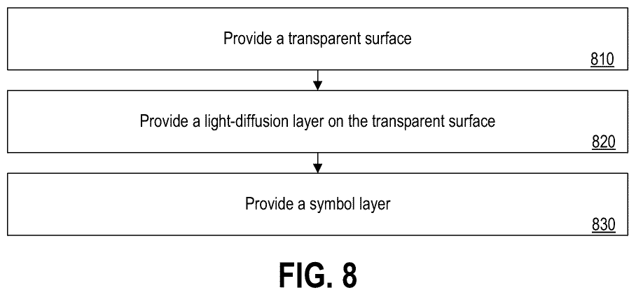

FIG. 8 illustrates an example of an operation for manufacturing a physical reel strip. The physical reel strip can be configured to be positioned in an EGM (e.g., EGM 300).

At block 810, a transparent surface is provided. In some embodiments, the transparent surface includes a clear polyester substrate.

At block 820, a light-diffusion layer is provided on the transparent surface. In some embodiments, the light-diffusion layer is printed on the transparent surface. In additional or alternative embodiments, the light-diffusion layers is a layer of ink including a non-solid pattern. In some examples, the ink can have a pattern, opacity, and/or color based on at least one of: an intensity of a light source in the slot machine; a distance between the light source in the slot machine and the position of the physical reel strip; and a game symbol associated with the physical reel strip. In additional or alternative examples, the layer of ink includes a specific pattern, opacity, and/or color configured to reduce the amount of the light that passes through the light-diffusion layer by a threshold amount. In additional or alternative examples, the pattern includes at least one of: a white-noise pattern; a chevron pattern; a checkered pattern; a polka-dot pattern; a waved-line pattern; and a striped pattern. In additional or alternative examples, the pattern includes horizontal blue stripes overlaid by vertical orange stripes. In additional or alternative examples, the layer of ink includes an ink having an opacity between 25% and 75%. In additional or alternative examples, the layer of ink includes at least one of: medium gray ink; blue ink; and purple ink.

In additional or alternative embodiments, the light-diffusion layer is configured to reduce an amount of light that passes through the physical reel strip by a threshold amount.

At block 830, a symbol layer is provided. In some embodiments, the symbol layer is attached to the light-diffusion layer or the transparent surface such that both the light-diffusion layer and the transparent surface are between the light source and the symbol layer. In some examples, the light-diffusion layer is configured to reduce backlighting hotspots on the symbol layer.

In additional or alternative embodiments, the transparent surface includes a front side and a back side. Providing the light-diffusion layer on the transparent surface includes printing the light-diffusion layer on the front side of the transparent surface. The symbol layer can be provided by printing the symbol layer on the light-diffusion layer.

In additional or alternative embodiments, the transparent surface includes a front side and a back side. Providing the light-diffusion layer on the transparent surface includes printing the light-diffusion layer on the back side of the transparent surface. The symbol layer can be provided by printing the symbol layer on the front side of the transparent surface.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A physical reel strip configured to be positioned in a slot machine, the reel strip comprising:
a transparent surface; and
a light-diffusion layer coupled to the transparent surface.

2. The physical reel strip of claim 1, wherein the light-diffusion layer comprises a layer of ink printed on the transparent surface.

3. The physical reel strip of claim 2, wherein the layer of ink comprises a pattern printed on the transparent surface.

4. The physical reel strip of claim 3, wherein the pattern comprises a type of pattern selected from a plurality of types of patterns based on a characteristic of the slot machine.

5. The physical reel strip of claim 3, wherein the pattern comprises horizontal blue stripes overlaid by vertical orange stripes.

6. The physical reel strip of claim 2, wherein the layer of ink comprises an ink having an opacity between 25% and 75%.

7. The physical reel strip of claim 2, wherein the layer of ink comprises an ink having a color selected from a plurality of ink colors based on a characteristic of the slot machine.

8. The physical reel strip of claim 1, wherein the light-diffusion layer is configured to reduce an amount of light that passes through the physical reel strip by a threshold amount.

9. The physical reel strip of claim 1, wherein the transparent surface includes a front side and a back side, and
wherein the light-diffusion layer is printed on the front side of the transparent surface,
the physical reel strip further comprising:
a symbol layer coupled to the light-diffusion layer.

10. The physical reel strip of claim 1, wherein the transparent surface includes a front side and a back side, and
wherein the light-diffusion layer is printed on the back side of the transparent surface,
the physical reel strip further comprising:
a symbol layer coupled to the front side of the transparent surface.

11. A method of providing a physical reel strip configured to be positioned in a slot machine, the method comprising:
providing a transparent surface; and
printing a light-diffusion layer on the transparent surface.

12. The method of claim 11, wherein printing the light-diffusion layer comprises printing a layer of ink comprising a non-solid pattern on the transparent surface.

13. The method of claim 12, wherein printing the layer of ink comprises printing the layer of ink using an ink having a pattern, an opacity, and a color based on:
an intensity of a light source in the slot machine;
a distance between the light source in the slot machine and the position of the physical reel strip; and
a game symbol associated with the physical reel strip.

14. The method of claim 11, wherein providing the transparent surface comprises providing a clear polyester substrate.

15. The method of claim 11, wherein the transparent surface includes a front side and a back side, and
wherein printing the light-diffusion layer on the transparent surface comprises printing the light-diffusion layer on the front side of the transparent surface,
the method further comprising:
printing a symbol layer on the light-diffusion layer.

16. The method of claim 11, wherein the transparent surface includes a front side and a back side, and
wherein printing the light-diffusion layer on the transparent surface comprises printing the light-diffusion layer on the back side of the transparent surface,
the method further comprising:
printing a symbol layer on the front side of the transparent surface.

17. A slot machine comprising:
a physical reel comprising:
a transparent surface; and
a light-diffusion layer attached to the transparent surface; and
a light source positioned behind a portion of the physical reel and configured to direct a light toward a portion of the physical reel,
wherein the light-diffusion layer is configured to reduce an amount of the light that passes through the light-diffusion layer by a threshold amount.

18. The slot machine of claim 17, wherein the physical reel further comprises a symbol layer attached to the light-diffusion layer or the transparent surface such that both the light-diffusion layer and the transparent surface are between the light source and the symbol layer, and
wherein the light-diffusion layer is configured to reduce backlighting hotspots on the symbol layer.

19. The slot machine of claim 17, further comprising:
a screen positioned on the opposite side of the physical reel from the light source and configured to display a symbol layer,
wherein the light-diffusion layer is configured to reduce backlighting hotspots on the symbol layer.

20. The slot machine of claim 17, wherein the light-diffusion layer comprises a layer of ink printed on the transparent surface, the layer of ink comprising a specific pattern, opacity, and/or color configured to reduce the amount of the light that passes through the light-diffusion layer by the threshold amount.
